(19) United States
(12) Patent Application Publication
(10) Pub. No.: US 2004/0253286 A1
(43) Pub. Date: Dec. 16, 2004

(54) Non-lethal organic bird repellant

(76) Inventors: Robert J. Pado JR., Desert Hot Springs, CA (US); Christine Linda Hemphill, Desert Hot Springs, CA (US)

Correspondence Address: Robert Joseph Pado Jr., 12495 Avenida Alta Loma, Desert Hot Springs, CA, 92240, US

(21) Appl. No.: 10/459,057

(22) Filed: Jun. 11, 2003

(51) Int. Cl. A01N 25/00; A01N 29/04; A01N 27/00

(52) U.S. Cl. 424/405; 514/751; 514/765

(57) ABSTRACT

A new use for chemicals paradichlorobenzene (10) and naphthalene (20), colorless or white, volatile crystals with a strong coal tar odor, that when positioned in areas where birds gather or roost, such as rooftops, eaves or ledges, diffuses into the surrounding air resulting in birds being deterred from affected area.

### CROSS-REFERENCE TO RELATED APPLICATIONS

This application claims the benefits of DDP's Ser. Nr. 513940 filed 2002 Jun. 19 and Ser. Nr. 522436 filed 2002 Nov. 25 by the present inventors.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to animal bio-repellants, specifically to such non-lethal organic bio-repellants that are effective in preventing or minimizing for extended periods of time the occupation, damaging, or soiling of various surfaces by nuisance birds.

2. Background of Invention

Various means are in existence, which prevent birds from causing direct or indirect damage to humans and property. Unattended prevention methods against damage caused by the bird species such as sparrow, crows, or pigeons have been developed in prior art but none of theses has shown satisfactory results for extended periods of time.

An unpleasant sanitation problem results from droppings of pigeons, which form their nests under house eves, carports, in garages, on business signs and landings, etc.

Already known in prior art, there are visual scaring devices, such as plastic owls, a huge cloth eye, flashing lights, and reflective devices that rely upon appeal to the birds' vision in order to generate sufficient impression signifying vigilance or terror. Drawbacks with visual scaring methods are that they cannot be seen at night, create faint reflection during overcast, and the birds become accustomed to their presence.

Additionally known in prior art are sound, frequency, and sonic emitting devices. The drawbacks of sound devices are that a power supply is generally necessary, sounds are annoying to humans, and birds become accustomed to sounds.

Wire and barb type devices have been shown in prior art. Drawbacks to wire and barb type devices are that they're very unsightly and complex. Additionally birds just place nesting material on top of said devices to build nests.

Rotational devices have been shown in prior art. Drawbacks to rotational devices are that they generally need a power source, contain mechanical parts that can get clogged or stuck, have limited coverage, are unsightly, and birds just move to a different area.

Shock systems have been shown in prior art. Drawbacks to shock system devices are that a power supply is needed, and they are limited to a defined region.

Chemical aversions have been shown in prior art. Drawbacks to chemical aversions are that they're mainly used within agricultural production such as feed and seed loss. Additionally birds must ingest chemicals in order to deter unwanted behaviors.

### BACKGROUND OF INVENTION—OBJECTS AND ADVANTAGES

Accordingly, several objects and advantages of my invention are:

(a) to provide a bird repellant which has no mechanical parts;

(b) to provide a bird repellant which requires no power supply;

(c) to provide a bird repellant which remains effective at night;

(d) to provide a bird repellant which has a range of coverage;

(e) to provide a bird repellant which is small and essentially out of human sight;

(f) to provide a bird repellant which birds won't build nests over;

(g) to provide a bird repellant which birds don't get accustomed to;

(h) to provide a bird repellant which birds won't ingest; and

(i) to provide a bird repellant which is generally not annoying to humans.

Other objects and advantages are:

(a) to provide a bird repellant which is low cost;

(b) to provide a bird repellant which is simple and inexpensive to manufacture;

(c) to provide a bird repellant which is easy to use; and

(d) to provide a bird repellant which is organic.

Further objects and advantages of my invention will become apparent from a consideration of the ensuing description and drawings.

### SUMMARY

In accordance with the present invention, an organic non-lethal bird repellant composition effective in preventing or minimizing the occupation, damaging, or soiling of various surfaces by unwanted birds comprises, a bio-repellant of paradichlorobenzene and, or, naphthalene.

### DRAWINGS—FIGURES

In the drawings:

FIG. 1 shows a chemical structure formula of paradichlorobenzene.

FIG. 2 shows a chemical structure formula of naphthalene.

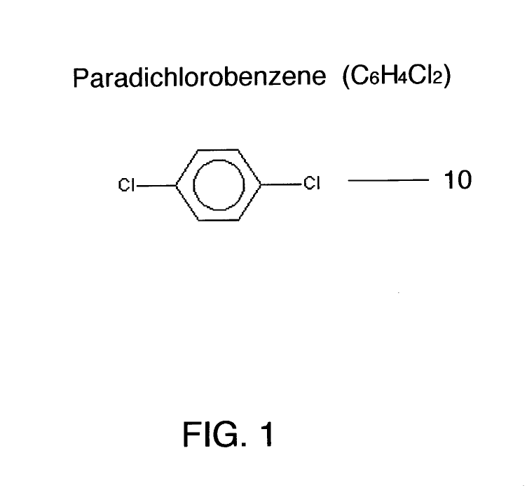

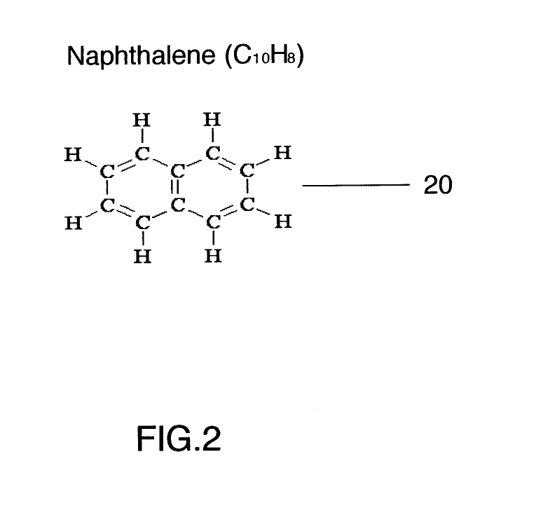

### DETAILED DESCRIPTION—FIGS. 1 AND 2

A chemical structure and formula of the present invention is illustrated in FIG. 1 (paradichlorobenzene) and FIG. 2 (naphthalene). The chemicals 10 and 20 are colorless or white, volatile crystals with a strong coal tar odor. The chemicals are stable at room temperature in a sealed container. Thus the chemicals when positioned in area birds gather or roost diffuse into the surrounding area resulting in birds being deterred from area.

### Operation—FIGS. 1, 2

The manner of using paradichlorobenzene 10 and/or naphthalene 20 to deter birds is to position chemical(s) in area birds gather or roost, such as rooftops, eaves, or ledges. The chemical(s) diffuse into the surrounding air, while I believe irritates bird's sinus's and eyes, I don't wish to be bound by this, resulting in birds being deterred from area.

### Advantages

From the description above, a number of advantages of my non-lethal bird deterrent become evident:

(a) Provides a bird repellant which has no mechanical parts.

(b) Provides a bird repellant which requires no power supply.

(c) Provides a bird repellant which remains effective at night.

(d) Provides a bird repellant which has a range of coverage.

(e) Provides a bird repellant, which is small and essentially out of human sight.

(f) Provides a bird repellant which birds don't get accustomed to.

(g) Provides a bird repellant, which birds won't ingest.

(h) Provides a bird repellant which is generally not annoying to humans.

(i) Provides a bird repellant, which is low cost.

(j) Provides a bird repellant which is simple and inexpensive to manufacture.

(k) Provides a bird repellant which is easy to use.

(l) Provides a bird repellant which is organic.

(m) Provides a bird repellant which birds won't build nest over.

### Conclusion, Ramifications, and Scope

Accordingly the reader will see that the chemicals of the invention have a new unappreciated use to deter birds. While my above description contains specificity, this should not be construed as a limitation on the scope of the invention, but rather as an example of one preferred method thereof. Many other variations are possible. For example the chemicals can have minor variations in form, color, size, scent, shape, made integrally or separately, or vary in method of application.

Thus the scope of the invention should be determined not by the embodiments illustrated, but by the appended claims and their legal equivalents.

We claim:

1. A method for repelling birds selected from the group consisting of paradichlorobenzene and naphthalene in an amount effective to repel birds.
